(19) United States
(12) Patent Application Publication
(10) Pub. No.: US 2006/0201078 A1
(43) Pub. Date: Sep. 14, 2006

(54) Reinforced glass and method

(75) Inventors: Geoffrey Card, Chaska, MN (US); Harry Alberini, Walpole, MA (US)

Correspondence Address: SCHWEGMAN, LUNDBERG, WOESSNER & KLUTH, P.A., P.O. BOX 2938, MINNEAPOLIS, MN, 55402, US

(73) Assignee: Westcrowns Inc.

(21) Appl. No.: 11/077,243

(22) Filed: Mar. 10, 2005

(51) Int. Cl. E06B 3/00

(52) U.S. Cl. 52/204.5

(57) ABSTRACT

A glazing structure is provided that provides increased safety without sacrificing architectural advantages. One example of glazing structures provided satisfies building code requirements for hurricane conditions. Architectural advantages provided by configurations shown include enhanced structural support due to glass members with at least one side portion. The addition of one or more side portions on glass members allows large areas of glass to be suspended without intermediate structural supports such as steel or other metal members.

### TECHNICAL FIELD

This invention relates to glazing structures. Specifically, this invention relates to methods and products for safety reinforcement of glazing structures.

### BACKGROUND

Glazing assemblies are used in a variety of architectural applications from exterior building surfaces to interior dividing walls, etc. Glazing assemblies such as those provided by Pilkington of St. Helens, UK provide attractive architectural surfaces while also providing structural support. However, a catastrophic event such as a hurricane, tornado, explosion, gun fire, etc. poses a danger to people near a glazing assembly. Dangers in such catastrophic events include shards of broken glass, and openings in an exterior surface that allow high winds or other pressure differentials to blow dangerous debris around inside a building or other structure.

What is needed is an improved glazing product and method that improves safety and strength. What is also needed is an improved glazing product that provides architectural features such as the ability to span large areas without the need for intermediate support structures.

### BRIEF DESCRIPTION OF THE DRAWINGS

FIG. 1 shows a side view of a glazing assembly according to an embodiment of the invention.

FIG. 2 shows a top view of a glazing sub-assembly according to an embodiment of the invention.

FIG. 3 shows a flow diagram of a method according to an embodiment of the invention.

FIG. 4 shows a top view of a glazing assembly according to an embodiment of the invention.

### DETAILED DESCRIPTION

In the following detailed description, reference is made to the accompanying drawings which form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, mechanical, logical changes, etc. may be made without departing from the scope of the present invention.

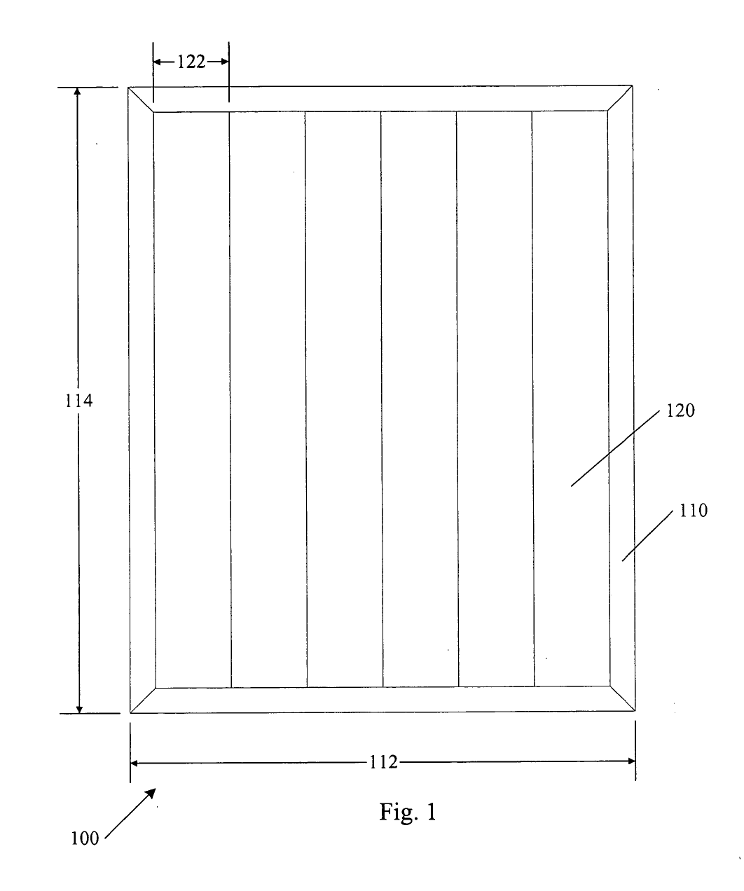

FIG. 1 shows a glazing assembly 100. A frame 110 is shown with a number of glazing sub-assemblies 120 included within the frame 110. In one embodiment, the frame 110 includes a width 112 of 3′-8⅛″. In one embodiment, the frame 110 includes a height 114 of 10′. In one embodiment, an individual glazing sub-assembly 120 includes a width 122 of 10⅜″. Although specific dimensions are shown the invention is not so limited. The dimensions shown in the Figures are examples of selected embodiments. One of ordinary skill in the art, having the benefit of the present disclosure will recognize that several other dimensions are possible given the unique structural characteristics of glazing assemblies shown.

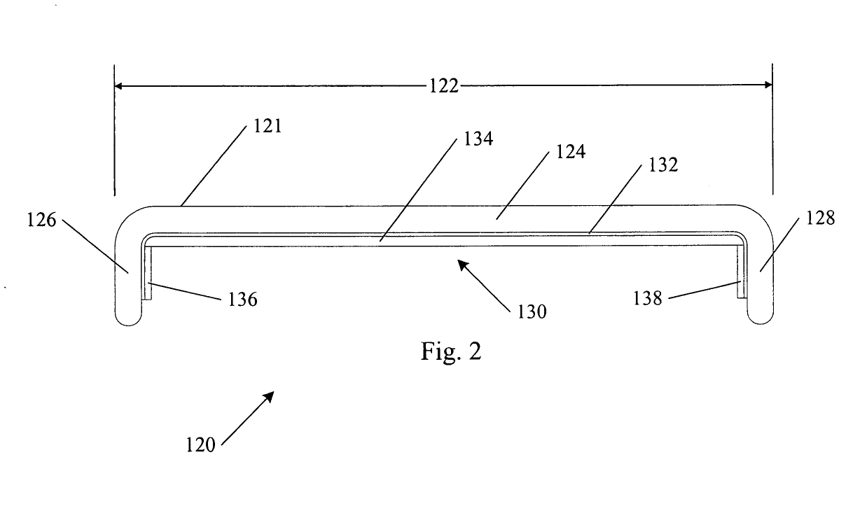

FIG. 2 shows a glazing sub-assembly or glazing element 120 similar to those shown in FIG. 1. The glazing sub-assembly 120 includes a glass member 121. In one embodiment, the glass member 121 includes a continuous glass member. In one embodiment, the glass member 121 includes a body portion 124, a first side portion 126 and a second side portion 128. In one embodiment, the first and second side portions 126, 128 are formed by rolling a continuous glass sheet while it is hot enough for plastic flow. In one embodiment, the glass member includes K25/60/7 glass.

FIG. 2 further shows a reinforcing assembly 130 attached to a surface of the glass member 121. In one embodiment, the reinforcing assembly 130 includes a bonding layer 132. One suitable bonding layer is provided by Security Impact Glass of West Palm Beach, Fla. In one embodiment, the bonding layer 132 includes a polymer layer that adheres to other surfaces upon heating to a certain temperature. In one embodiment the polymer layer includes a thermoset polymer that reacts chemically upon the application of heat. In one embodiment, the polymer layer includes a thermoplastic polymer that flows over a certain temperature, but does not change on a molecular level. In one embodiment, the polymer layer is not tacky or adhesive until heat is applied. Embodiments using such polymer layers are easy to assemble without the bonding layer accidentally sticking in the wrong place, or to itself. In one embodiment, the bonding layer 132 includes a sheet of adhesive that is applied as a unit. In one embodiment, the bonding layer 132 includes a flowable adhesive that is applied with an applicator such as a brush, squeegee, etc. One of ordinary skill in the art, upon reading the present disclosure, will recognize that several bonding layers are possible within the scope of the invention.

In one embodiment, a first impact resistant polymer portion 134 is applied to the body portion 124 of the glass member 121. In one embodiment a second impact resistant polymer portion 136 is applied to the first side portion 126 of the glass member 121. In one embodiment a third impact resistant polymer portion 138 is applied to the second side portion 128 of the glass member 121. Although multiple components of impact resistant polymer are shown in FIG. 2, the invention is not so limited. A single piece impact resistant polymer portion, or an impact resistant polymer portion made of a different number of components is also within the scope of the invention.

An advantage to the three component impact resistant polymer portion as shown in FIG. 2 includes an ability to adapt to manufacturing size variations. If the width 122 of various glass members 121 varies slightly in manufacturing, then a corresponding width of the first impact resistant polymer portion 134 can be easily varied. Once the width of the first impact resistant polymer portion 134 is adjusted, the addition of the second impact resistant polymer portion 136 and the third impact resistant polymer portion 138 is easily accomplished for a custom fit to a particular glass member 121.

In one embodiment, including an impact resistant polymer portion covering at least a portion of one or more side portions 126, 128 of the glass member 121 provides increased safety. If for example, only the body portion 124 of the glass member 121 were reinforced, an impact from an object during a catastrophic event could break out the body portion from the side portions. The addition of impact resistant polymer portions covering at least a portion of one or more side portions 126, 128 significantly increases the strength of each glazing sub-assembly 120.

In one embodiment, a material of the impact resistant polymer portions includes polycarbonate. In one embodiment, a thickness of one or more of the impact resistant polymer portions includes 3/16″ thickness. In one embodiment, the body portion 124 includes 3/16″ thickness, and the side portions 126, 128 include ⅛″ thickness. In one embodiment, all impact resistant polymer portions include polycarbonate. In one embodiment, material choices of selected impact resistant polymer portions is varied. In one embodiment, the impact resistant polymer portions are clear or translucent to provide a desired light transmittance. In one embodiment, one or more of the impact resistant polymer portions includes a composite configuration where fibers, wires, or other embedded portion is encased in a polymer matrix.

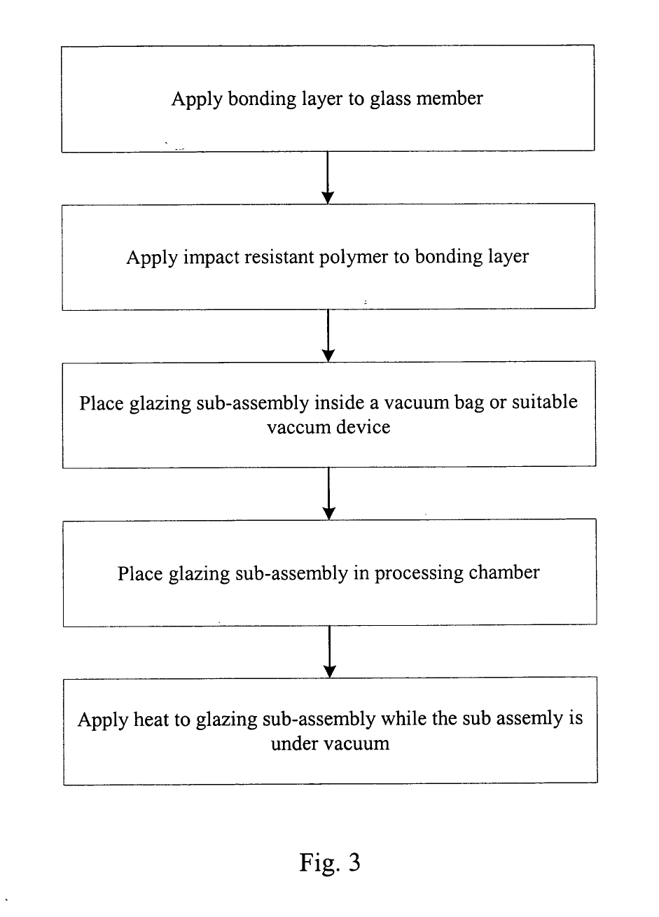

FIG. 3 shows one method of manufacture according to an embodiment of the invention. A bonding layer, such as bonding layer 132 described above, is applied to a glass member such as glass member 121 described above. In one embodiment, the glass member includes at least one side member formed at an angle to a body portion as described in embodiments above. An impact resistant polymer portion is then applied to the bonding layer. In one embodiment, the impact resistant polymer portion includes multiple portions such as three portions described in embodiments above.

In one embodiment, selected components, are clipped together and pre-heated to hold them in place during subsequent manufacture operations. In one example, a side portion of an impact resistant polymer portion is clipped to a side portion of a glass member with a bonding layer between. The clipped components are pre-heated to activate a portion of the bonding layer and hold components in place. In one embodiment, subsequent operations such as vacuum bagging described below are easier to perform with components held in place due to pre-heating.

In one embodiment, the sub-assembly of the glass member, the bonding layer, and the impact resistant polymer portion is then placed inside a vacuum bag. Other vacuum devices are also within the scope of the invention. Processing of the sub-assembly is then carried out using a vacuum source, and heat. In one embodiment, the sub-assembly is individually vacuum sealed inside a vacuum bag. Using this method, a sub-assembly inside a sealed vacuum bag can be stored under vacuum until the next manufacturing step such as heating. In one embodiment, a vacuum is drawn concurrent to heating in a processing chamber. The vacuum procedure removes any air that may have been trapped in the impact resistant polymer portion or the bonding layer. Although the term vacuum is used, it should be appreciated that varying degrees of pressure lower than atmospheric pressure produce the desired forces on the sub-assembly.

In one embodiment, the sub-assembly is placed into a processing chamber such as an autoclave. In one embodiment, heat is then applied to the sub-assembly to activate the bonding layer. Although heat is used to activate the bonding layer in the method of FIG. 3, other activation methods such as chemical curing, or solvent out gassing are also within the scope of the invention.

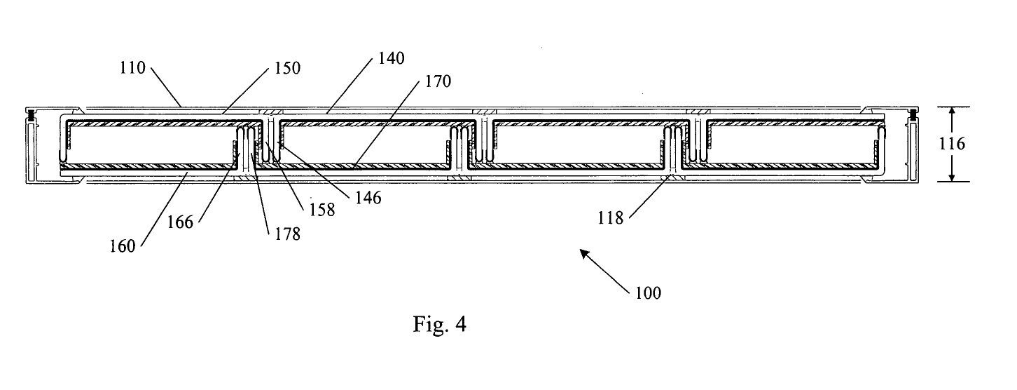

FIG. 4 shows a top view of the glazing assembly 100 similar to the embodiment shown in FIG. 1. A frame 110 is shown housing a number of glazing sub-assemblies. The frame 110 is shown with a thickness 116. In one embodiment the thickness 116 includes 3¾″. A first glazing sub-assembly 140, a second glazing sub-assembly 150, a third glazing sub-assembly 160, and a fourth glazing sub-assembly 170 are shown. In one embodiment, the glazing sub-assemblies are similar to embodiments described above. In one embodiment, such as at ends of the glazing assembly 100 only one side portion is included on a glazing sub-assembly. One example of this configuration is shown in the third glazing sub-assembly 160.

In one embodiment, an interlocking arrangement of glazing sub-assemblies provides ease of manufacturing of the glazing assembly 100, and allows for architectural features such as curved walls. In the embodiment shown in FIG. 4, a second side 158 of the second glazing sub-assembly 150 and a first side 146 of the first glazing sub-assembly 140 are butted against one another. A first side 166 of the third glazing sub-assembly 160 and a second side 178 of the fourth glazing sub-assembly 170 are likewise butted against one another. The first side 146 and second side 158 are then butted against the first side 166 and second side 178 to form interlocking glazing sub-assemblies in a back to back configuration.

One advantage of this configuration is that it allows large areas of glass to be suspended without intermediate structural supports such as steel or other metal members. Another advantage is that the glazing assembly 100 can be curved (not shown) along its long axis to provide a curved wall if desired. Another advantage of the configuration shown in FIG. 4 includes high thermal insulation due to the double glazing effect of glazing sub-assemblies being placed back to back. Further, in the configuration shown in FIG. 4, the safety provided by each reinforcing assembly such as reinforcing assembly 130 is doubled by having a back to back glazing sub-assembly configuration. In one embodiment, a flexible sealer 118 is included to further seal the glazing sub-assemblies within the glazing assembly 100.

Catastrophic events such as a hurricanes, tornados, explosions, gun fire, etc. pose a danger to people near a glazing assembly. In the case of a hurricane, a large missile impact test (SBCCI SSTD 12) has been implemented in the state of Florida to ensure safety for building occupants. Selected embodiments described above satisfy the large impact missile test. Features described above such as a reinforcing assembly 130 provide increased safety without sacrificing architectural advantages. Architectural advantages provided by configurations described above include structural support due to glass members with at least one side portion. The addition of one or more side portions on glass members allows large areas of glass to be suspended without intermediate structural supports such as steel or other metal members. As described above, configurations such as those in FIG. 4 also facilitate curved glass walls.

Although selected advantages are detailed above, the list is not intended to be exhaustive. Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. It is to be understood that the above description is intended to be illustrative, and not restrictive. Combinations of the above embodiments, and other embodiments will be apparent to those of skill in the art upon reviewing the above description. The scope of the invention includes any other applications in which the above structures and fabrication methods are used. The scope of the invention should be determined with reference to the appended claims, along with the full scope of equivalents to which such claims are entitled.

What is claimed is:

1. A glazing element, comprising:
a continuous glass member including:
a body portion having a top edge, a bottom edge and a pair of side edges;
at least one side portion integrally formed along a side edge, wherein the side portion is angled with respect to the body portion;
an impact resistant polymer layer affixed to the continuous glass member over the body portion and at least part of the side portion.

2. The glazing element of claim 1, wherein at least one side portion includes a pair of side portions integrally formed at the pair of side edges, wherein the side portions are angled with respect to the body portion.

3. The glazing element of claim 2, wherein the impact resistant polymer layer includes a first sheet affixed to the body portion, and a pair of separate side sheets affixed to at least part of the pair of side portions.

4. The glazing element of claim 1, wherein the at least one side portion is angled at substantially 90 degrees with respect to the body portion.

5. The glazing element of claim 1, wherein the impact resistant polymer layer includes polycarbonate.

6. The glazing element of claim 1, wherein the impact resistant polymer layer is affixed to the continuous glass member using a polymer sheet that only exhibits adhesive characteristics upon heating.

7. A glazing assembly, comprising:
a frame;
a number of glazing sub-assemblies located within the frame, at least one of the sub-assemblies including:
a continuous glass member including:
a body portion having a top edge, a bottom edge and a pair of side edges;
a pair of side portions integrally formed at the pair of side edges, wherein the side portions are angled with respect to the body portion;
an impact resistant polymer layer affixed to the continuous glass member over the body portion and at least part of the pair of side portions.

8. The glazing assembly of claim 7, wherein the number of glazing sub-assemblies includes a first row of sub-assemblies located side by side to form a single layer wall.

9. The glazing assembly of claim 8, wherein the number of glazing sub-assemblies includes a second row of sub-assemblies located side by side to form a two layer wall.

10. The glazing element of claim 7, wherein the impact resistant polymer layer includes polycarbonate.

11. The glazing element of claim 7, wherein the impact resistant polymer layer includes a first sheet affixed to the body portion, and a pair of separate side sheets affixed to at least part of the pair of side portions.

12. A method of forming a glazing element, comprising:
affixing a first impact resistant polymer portion to a body portion of a continuous glass member;
affixing a second impact resistant polymer portion to at least part of a side portion of the continuous glass member;
wherein the side portion is integrally formed with the body portion of the continuous glass member, and is angled with respect to the body portion.

13. The method of claim 12, wherein the first impact resistant polymer portion is separate from the second impact resistant polymer portion.

14. The method of claim 12, wherein the first impact resistant polymer portion is integrally formed with the second impact resistant polymer portion.

15. The method of claim 12, wherein affixing the first impact resistant polymer portion to the body portion includes affixing using a polymer sheet that only exhibits adhesive characteristics upon heating, and
affixing the second impact resistant polymer portion to at least part of the side portion includes affixing using a polymer sheet that only exhibits adhesive characteristics upon heating.

16. The method of claim 12, further including performing affixing operations under a pressure lower than atmospheric pressure.

17. The method of claim 16, further including applying heat during an affixing operation.
